(19) United States
(12) Patent Application Publication
(10) Pub. No.: US 2026/0330068 A1
(43) Pub. Date: Oct. 22, 2026

(54) SECURE EXECUTION OF PROGRAMS BASED ON CERTIFICATES

(71) Applicant: Entrust Security UK Limited, CAMBRIDGE (GB)

(72) Inventors: Tomas ARREDONDO, CAMBRIDGE (GB); Jose SANCHEZ, CAMBRIDGE (GB); John PERRET, CAMBRIDGE (GB); Ian MERIN, CAMBRIDGE (GB); Pedro VALLADARES, CAMBRIDGE (GB)

(21) Appl. No.: 19/715,337

(22) Filed: Jun. 22, 2026

Related U.S. Application Data
(63) Continuation of application No. PCT/EP2024/088413, filed on Dec. 23, 2024.
(60) Provisional application No. 63/614,019, filed on Dec. 22, 2023.

(51) Int. Cl. G06F 21/64; G06F 21/53; G06F 21/60

(52) U.S. Cl. CPC G06F 21/64; G06F 21/53; G06F 21/602

(57) ABSTRACT

A computer system has access to multiple differing certificates in a certificate database. Each certificate is configuration information for an isolated execution environment, and different ones of the certificates specify different configuration information. The computer system is configured, upon receiving a request to execute a program, to initialize an isolated execution environment based on the configuration information of a selected certificate, and to execute the program in the isolated execution environment.

### CROSS REFERENCE TO RELATED APPLICATIONS

This application is a by-pass continuation of PCT/EP2024/088413 filed Dec. 22, 2023, which claims benefit from United States Provisional Application 63/614,019 filed Dec. 22, 2023, the entire disclosures of which are hereby incorporated by reference

### FIELD

The present invention relates to a method and device for secure execution of computer programs. The device may be a Hardware Security Module for example.

### BACKGROUND

A Hardware Security Module (HSM) is a device that securely stores and manages cryptographic keys, and performs a set of cryptographic algorithms. In some applications, it can be desirable to allow a user of the HSM to perform user-defined algorithms. In this way, a user is able to run a custom program that uses their cryptographic keys on the HSM. However, enabling a user to run a custom program on the HSM could compromise the security or operation of the HSM, and the information stored on the HSM. There is a continuing need to improve the security of such devices.

### SUMMARY OF THE INVENTION

In general terms, the present disclosure proposes that a computer system has access to a database storing a plurality of certificates. Each certificate is configuration information for defining an isolated execution environment. The computer system is configured, upon receiving a request from one of the users to execute a program, to select one of the certificates, to initialize an isolated execution environment in the computer system based on the configuration information of the selected certificate, and to execute the program in the isolated execution environment.

This has an advantage that different ones of the certificates may specify different configuration information. Thus, the configuration of an isolated execution environment can conveniently be tailored, and suitable configuration information can be selected and used to execute the program.

### BRIEF DESCRIPTION OF THE FIGURES

Devices and methods in accordance with non-limiting embodiments will now be described with reference to the accompanying figures in which:

FIG. 1 is a schematic illustration of an exemplary Hardware Security Module (HSM) device;

FIG. 2A is an illustration of the structure of the HSM;

FIG. 2B shows a container-based virtualization stack of the HSM device according to a comparative example;

FIG. 2C shows a process performed by the HSM device according to a comparative example to initiate an isolated execution environment;

FIG. 3 is an illustration of the structure of the HSM in a system which is an example of the present disclosure;

FIG. 4 shows a container-based virtualization stack in the example system of FIG. 3;

FIG. 5 illustrates a method performed by the example system of FIG. 3;

FIG. 6A illustrates schematically the operation of a first possible isolated environment initialization process performed by the example system of FIG. 3;

FIG. 6B illustrates schematically the operation of a second possible isolated environment initialization process performed by the example system of FIG. 3;

FIG. 7 illustrates schematically associations between multiple users and multiple certificates in the example system of FIG. 3;

FIG. 8 illustrates two certificates associated with one of the users in the example system of FIG. 3;

FIG. 9A illustrates a method of constructing a certificate for use in the example system of FIG. 3;

FIG. 9B illustrates a method of associating a user with a certificate in the example system of FIG. 3;

FIG. 10 illustrates a method of receiving a request to execute a program and implementing the request in the example system of FIG. 3;

FIG. 11 illustrates a first way of implementing a selection step of the method of

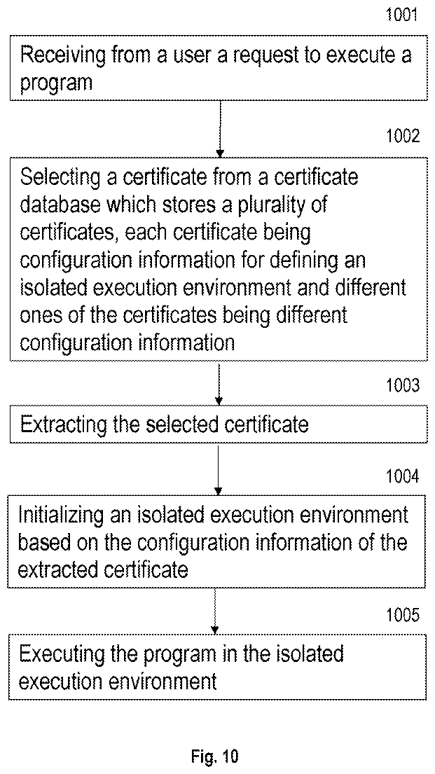

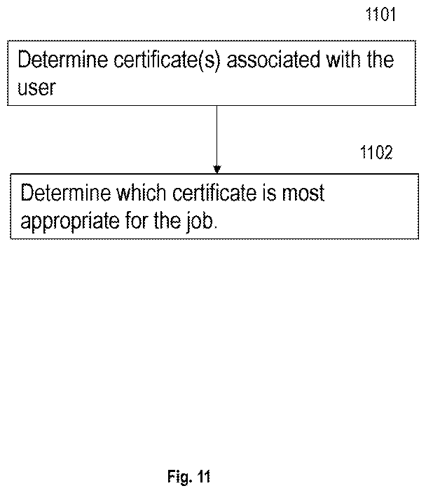

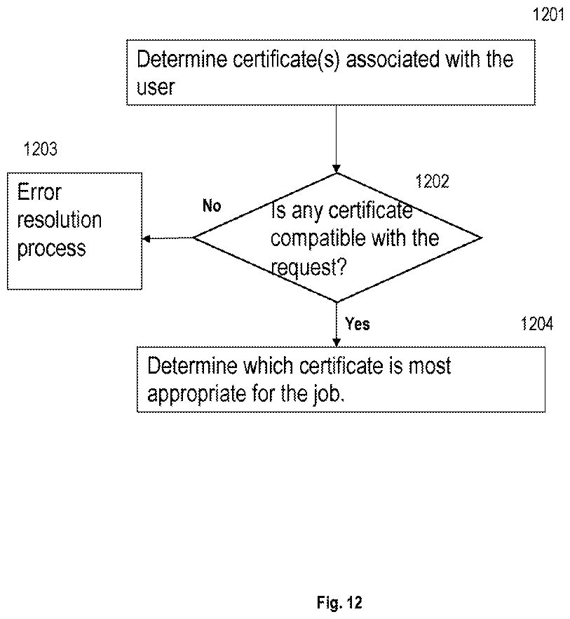

FIG. 10;

FIG. 12 illustrates a second way of implementing a selection step of the method of FIG. 10; and

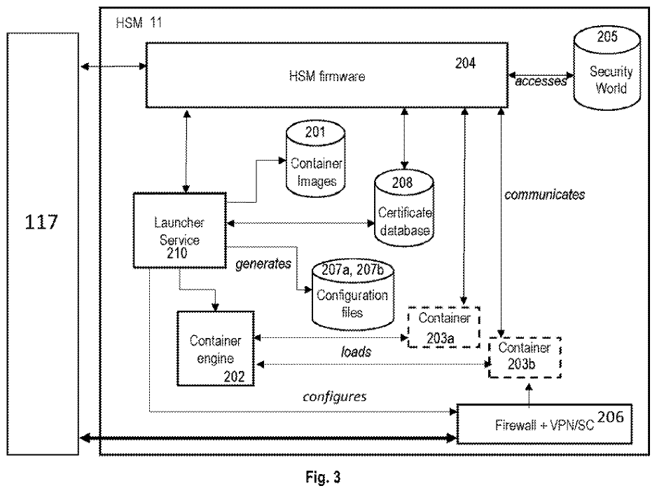

FIG. 13 illustrates a further method performed by the example system of FIG. 3.

The same reference numerals are used to designate corresponding elements in the illustrations of the comparative example and the example of the disclosure.

### DETAILED DESCRIPTION

A Hardware Security Module (HSM) is a device that securely stores and manages cryptographic keys, and performs a set of cryptographic algorithms. In some applications, it can be desirable to allow a user of the HSM to perform user-defined algorithms. In this way, a user is able to run a custom program that uses their cryptographic keys on the HSM. However, enabling a user to run a custom program on the HSM could compromise the security or operation of the HSM, and the information stored on the HSM.

Mitigating against such security issues can be important in a multi-tenant environment for example, where the HSM stores the cryptographic keys for multiple different users, who may not necessarily consent to their keys being shared with the other users.

In order to mitigate against such security issues, the user-defined program is executed in an isolated environment. For example, a container is used to execute and isolate a user-defined program.

The containers may be initialised with a standard configuration setting. For example, the configuration settings may be based on a whitelist provided by a trusted party, for example the manufacturer of the HSM. The whitelist may specify one or more of: the system calls that are considered safe for use by a user, the available devices that are considered safe for use by a user, the operating system capabilities that are considered “safe”. However, using a standard whitelist of configuration settings can result in a user-defined program being executed in a container that allows more functionality than the program needs in order to run. This can compromise the security or operation of the HSM, and the information stored on the HSM.

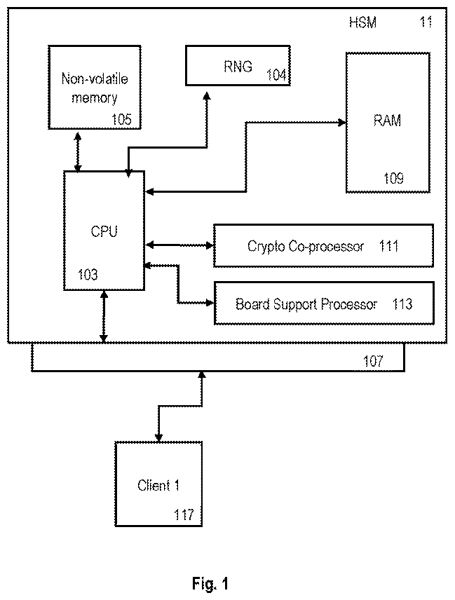

FIG. 1 shows a schematic illustration of a Hardware Security Module (HSM) device 11 in accordance with an example. The HSM 11 comprises a processing unit 103, a non-volatile memory 105 and working memory comprising Random Access Memory (RAM) 109.

In this example, the processing unit 103 is a Central Processing Unit (CPU) 103, however in other examples, the processing unit may comprise a field programmable gate array (FPGA) or an application specific integrated circuit (ASIC) for example, or a combination of multiple types of processing components.

The non-volatile memory 105 may include any form of non-volatile device memory such as flash, optical disks or magnetic hard drives for example. The non-volatile memory 105 may be physically secure and may be resistant to tamper by a third party, for example by the inclusion of physical security such as a membrane that covers the entire device, that cannot be removed without destroying the underlying physical hardware. The CPU 103 is in wired bi-directional communication with non-volatile memory 105 and the RAM 109.

Computer program code is stored in the non-volatile memory 105. When executed, a program is represented as a software product, or process, in the working memory. The processor 103 comprises logic circuitry that responds to and processes instructions in program code located in the working memory. The working memory comprises the RAM 109.

The below description refers to “HSM firmware” (or “main application”), which is a program comprising a set of computer instructions. The HSM firmware comprises machine code stored in the non-volatile memory 105 on the HSM 11. Also stored in the non-volatile memory 105 on the HSM 11 are any components necessary to execute the HSM firmware, including runtime system files. When executed, a copy of the main application machine code is loaded in the working memory. A “main application process” is the instance of the HSM firmware that is being executed, comprising the machine code in the working memory.

The HSM firmware comprises computer instructions embodying a set of one or more cryptographic algorithms. For example, the HSM firmware comprises computer instructions embodying one or more of the following cryptographic algorithms: cryptographic key generation; key derivation; encryption; decryption; and digital signature algorithms. The HSM firmware can be embedded in the non-volatile memory 105 of the Hardware Security Module 11 when the HSM 11 is manufactured by a trusted party, or can be provided by the trusted party as a whole or in part after manufacture. For instance, the HSM firmware can be introduced by the trusted party as a computer program product, which may be in the form of a download. Alternatively, modifications to existing HSM firmware can be made by the trusted party by an update or plug-in.

The HSM 11 runs an operating system, for example a Linux operating system. The operating system comprises system software that manages the hardware and software resources of the HSM 11, and acts as an intermediary between the HSM firmware and the HSM hardware.

In use, the HSM device 11 may be located within a larger system. In this case, the HSM 11 is communicatively coupled to a computer or a server device in the larger system (for example) through interface 107, which comprises a communication link to the computer or server device. For example, the HSM 11 can be implemented in the form of a PCI express card directly plugged into the computer or server device, or the HSM device 11 can be communicatively connected to the computer or server device by a USB connection. In use, the HSM device 11 receives user requests through interface 107.

In one example, the HSM 11 is located in a user system. In this case, the user system has a dedicated local HSM 11 device. The HSM 11 is directly coupled to a client (user) computing device 117 (controlled by the user) through interface 107, for example the HSM device 11 can be a PCI express card directly plugged into the computing device 117 or can be communicatively connected to the client computing device 117 by a USB connection. The client computing device 117 may be a server or an end-user computing device for example.

In a different example, the HSM 11 is located in a host system (not shown) which is separate to the client computing device 117. The host system may be a service provider system for example. In this case, the client computer 117 communicates with a computer or server device in the host system. The HSM device 11 is directly coupled to the computer or server device in the host system through interface 107. For example, the HSM device 11 can be a PCI express card directly plugged into the computer or server device in the host system, or the HSM device 11 can be communicatively connected to the computer or server device by a USB connection. The client computing device 117 is thus communicatively coupled to the HSM device 11 through a computer or server device present in the host system (which is not shown in FIG. 1). Communication between the user computing device 117 and the host computer or server device (not shown in FIG. 1) may be performed via an Internet connection for example.

The non-volatile memory 105 stores one or more cryptographic keys associated with a user. The one or more cryptographic application keys are associated with the user for use with the cryptographic algorithms embodied in the HSM firmware. The application key(s) may be securely stored outside of the HSM device 11 using a master key. For example, the application key(s) may be encrypted using Advanced Encryption Standard (AES) encryption (for example) using the master key stored in the HSM device. The encrypted application key(s) can then be transmitted to a separate external device for storage. The master key however is stored on the HSM device 11.

The application keys associated with the user are used to perform one or more cryptographic algorithms embodied in the HSM firmware. When a user request to perform an algorithm is received at the HSM 11, the relevant application key or keys are retrieved by the HSM 11, decrypted using the master key, and loaded into the RAM 109 space of the HSM firmware process. They may then be used by the HSM 11 to perform one or more cryptographic algorithms, including performing various encryption and decryption algorithms, and performing digital signature algorithms.

The HSM device 11 further comprises a Board Support Processor 113. Board Support Processor 113 is configured to communicate with a plurality of on-board sensors, monitoring the operation of the main CPU and the other hardware components of the Hardware Security Module 11. The sensors may include, but are not limited to, CPU and/or board temperature sensors, voltage sensors and/or current sensors.

The HSM further comprises a random number generator component 104, such as a quantum entropy source.

In some examples, the HSM device 11 may further comprise a crypto co-processor 111. The crypto-coprocessor 111 may perform various standard cryptographic functions in hardware, for example various encryption and decryption algorithms, and digital signature algorithms. In other examples, this functionality is integrated in the main processing unit 103. For example, the main processing unit 103 may comprise a system on a chip FPGA (SoC FPGA), where the various standard cryptographic functions are implemented in hardware in the programmable logic.

Various other components may be included which are not shown in FIG. 1.

Although a HSM device is described here, the invention is not limited to such, and the below described methods may be implemented on various devices used for performing cryptographic algorithms and/or storing cryptographic keys. For example, a software emulator running on a general purpose computing device or server may enable the computing device or server to behave like a HSM device. In this case, a computer program running in the computer device or server emulates a HSM device, and the below described methods are implemented on the computer device or server in this environment.

As discussed above, the HSM firmware comprises computer instructions embodying a set of one or more cryptographic algorithms. However, a user may wish to perform an algorithm for which computer program code is not provided in the HSM firmware on the HSM device 11. In light of this, there is provided functionality to receive and execute a user-defined program at the HSM 11, as will be described in more detail below.

The user-defined program may be specified in a form that can be executed by the CPU 103 (e.g. in machine code). In other examples, the user-defined program is provided to the HSM 11 in an intermediate form, and is then converted by the HSM 11 into a form that can be executed by the CPU 103. Enabling user-defined code to be executed on the HSM provides flexibility, and allows a user to execute custom algorithms on the HSMs that make use of their cryptographic keys.

However, allowing a user to unconditionally execute arbitrary user-defined code on a Hardware Security Module (HSM) 11 may compromise the operation and security of the HSM 11. The user code is therefore executed in an isolated environment on the HSM device 11. For example, the HSM 11 uses containers to execute user code. A container is an example of an isolated environment. Using the container to execute the code isolates the user-defined code from the rest of the HSM runtime environment. A container is an executable unit of software in which application code is packed along with its libraries and dependencies. Containers take advantage of a form of Operating System (OS) virtualization in which features of the OS are leveraged to isolate processes. The containers may be referred to as OS-level containers because they are managed by the OS.

Isolating the user-defined program from the rest of the run-time environment creates a consistent environment for executing user-defined programs and limits exposure to rest of the HSM runtime environment. Executing the user-defined code in a container thus provides a sandbox in which the execution environment can be controlled and isolated from the HSM firmware. This mitigates against a user accidentally or deliberately introducing a security vulnerability to the HSM.

As discussed above, in an example the HSM 11 runs the Linux operating system. The Linux operating system may support the use of Linux containers (e.g. Linux LXC containers, and/or Linux LXD containers). Where Linux containers are used, Linux container technology provides the ability to control the operation of the container, e.g. by limiting the operations that can be performed by the container. The configuration of a container can be controlled to limit the operations that can be performed by code being executed in the container. The configuration associated with each Linux container is defined in a configuration file. For example, the container can be configured in such a way that it limits the system calls to the Operating System (OS) that can be made by the code executed in the container. Linux has over 300 system calls. Allowing a user defined program to access all 300 system calls could give rise to a security vulnerability. To this end, the system calls that can be made by programs executing in a container may be limited to a “whitelist” of system calls—this may be around 100 system calls for example. These are the system calls that are considered to be “safe” by a trusted party, for example a system administrator. Restricting the number of system calls reduces the attack surface, i.e. the potential ways in which the security of the HSM can be compromised. The available system calls can be limited using a seccomp profile, which specifies the allowed system calls. The seccomp profile is used to configure a seccomp filter when the container executing the user-defined program is initialised. The container can additionally or alternatively be configured in such a way that it limits the devices (e.g. storage devices) that can be accessed by the code executed in the container for example.

By controlling the configuration of the containers used to execute user code, even if the user-defined code contains malicious elements, the effect it could have on the security of the HSM (in particular the security of the information, such as cryptographic keys, stored on the HSM) is limited. For example, if the user-defined code has been compromised by a malicious third party, without knowledge of the user, the security issues caused by running the code on the HSM are limited by isolating the user code in the isolated environment (the container in this example).

This can be particularly important in a multi-tenant environment where the HSM 11 has access to (e.g. stores) cryptographic keys associated with other users. In this case, without sufficient controls in place, a user-defined program from a first user of the HSM 11 could be used to compromise the cryptographic keys of another user.

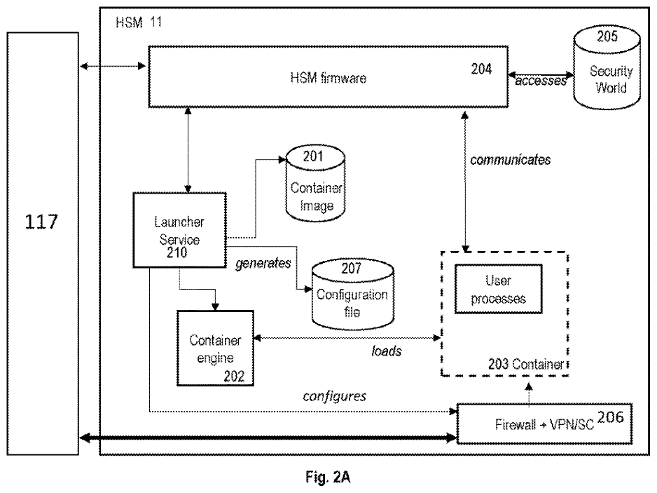

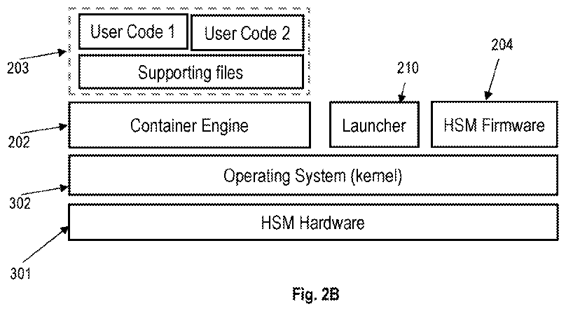

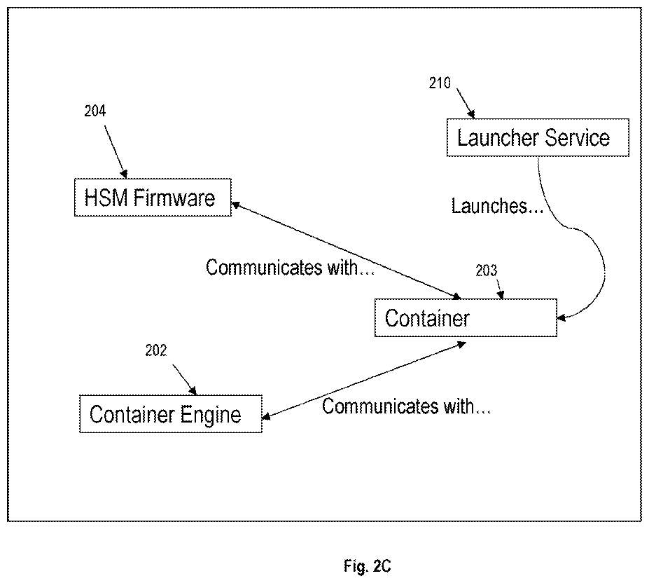

FIG. 2A shows a logical diagram of a Hardware Security Module 11 according to a comparative example. In particular, FIG. 2A shows an illustration of various software processes being executed by the HSM 11. The HSM 11 may be a HSM 11 such as described in relation to FIG. 1 for example.

As discussed above, a container 203 is a virtual runtime environment that runs on top of an operating system (OS) kernel. The container 203 isolates one or more running processes running in the container 203 from the rest of the system. The container 203 is an example of an isolated environment.

In this example, a file 201 corresponding to the container 203 is provided by the user in a request transmitted to the HSM 11. This file may also be referred to as the container image 201 or the container repository. Once received, the container image 201 is stored in the non-volatile memory 105 of the HSM 11. When run, the container image 201 becomes the container 203. The container image 201 comprises program code corresponding to the programs to be run in the container. In one example, once created, the container image 201 is immutable (i.e. such that it cannot be changed). The container image 201 further comprises all libraries, supporting files and programs, and any language interpreter required to run (execute) these programs on the HSM 11. This means that when the container 203 is running, the programs may run without requiring access to files outside the container 203.

The launcher service 210 comprises a set of program instructions that, when executed, store the received container image 201 in the non-volatile memory 105 in response to receiving a command to start the container 203, and initiate and run the container 203 by sending an instruction to the container engine 202 to initiate a container 203 according to the container image 201 and a configuration file 207. The container configuration file 207 may be a lxc. conf file for example.

The client device 117 communicates with the launcher service 210 through a first secure channel. When a request comprising a container image 201 is received from the client device 117 through the first secure channel, the launcher service 210 stores the received container image 201 in non-volatile memory 105, then transmits an instruction to a container engine 202 to extract the container image 201 in the non-volatile memory 105, initialize a container according to the container image 201 and a container configuration specified in a configuration file 207.

The configuration file 207 may be a default configuration file stored on the HSM 11 or may be generated by the launcher service 210 in response to the request in the manner described in more detail below. The launcher service 210 takes the configuration file 207 and a request to initiate a container from the user, and instructs the container engine 202 to start a container. The configuration file 207 and container image 201 are provided to the container engine 202 by the launcher service 210. A container for executing the user-defined program is thus initialised based on a container image 201 and a configuration file 207. The container configuration file 207 defines, amongst other things, the capabilities of the container, the devices that are accessible to the container, and a seccomp filter that controls the system calls that can be made by programs executing in the container.

The container engine 202 is configured to initiate the container 203 in response to a request from the launcher service 210. The container engine 202 processes the configuration settings provided in the configuration file 207 and sends this information to the OS kernel to set up the container. The container engine 202 makes one or more API calls to the Operating System (OS) kernel. The OS kernel implements the isolation of the container 203, and enforces the part of the non-volatile memory 105 and network connections available to the container 203. The OS kernel, together with the memory management unit within the CPU 103, allocates part of the RAM 109 to the container, and prevents writing to other parts of the RAM 109. In this way, the container isolation is implemented by the OS kernel, using hardware components such as the memory management unit. Consequently a container is an OS-level virtualisation tool. Once running, a container 203 is a set of one or more processes that are isolated from the rest of the system. Example implementations of the container engine 202 include Linux LXC and LXD.

The configuration settings specified in the configuration file 207 are implemented by and enforced by the OS kernel. The OS kernel is configured to process requests from the container 203 (e.g. system calls) and action these requests depending on the configuration settings of the container (e.g. whether a specific system call is enabled for the container). The configuration settings of the container are maintained whilst the container is running, and can only be modified by an authorised user, as described below.

Once running, communication between the client device 117 and the container 203 may be performed via a firewall, and a virtual private network or third secure channel 206 configured by the launcher service 210. The third secure channel may be configured by the user. The HSM 11 also executes a main application process (HSM firmware) 204. The HSM firmware has been described previously, and comprises computer program code for managing, generating and manipulating cryptographic keys. For example, the main application process includes one or more of: predefined algorithms for generating cryptographic keys, code for loading a cryptographic key onto the HSM 11, code for retrieving a cryptographic key stored on the HSM 11 etc. The firmware 204 may include a root certification authority (CA) certificate, which is accessed when the firmware is used. The HSM firmware 204 is configured to access security world data 205 stored in the non-volatile memory 105 of the HSM 11. Security world data 205 includes cryptographic keys associated with a user. Communication between the client device 117 and the HSM firmware 204 is performed via a second secure channel. In this example, the second secure channel is implemented using the secure shell (SSH) protocol.

The HSM firmware 204 may communicate with the container 203, to provide data (e.g. security world data 205) for use by the user processes executed within the container 203. For example, the HSM firmware 204 communicates with the container 203 via an internal network port of the container 203. In an example, the container 203 is used to perform a user-defined algorithm that uses a cryptographic key associated with the user.

The HSM main application code defining the HSM firmware 204 is provided by a trusted party. For example, the main application code can be embedded in the non-volatile memory when the HSM 11 is manufactured, or can be provided by the trusted party by an update or plug-in. However, a user may wish to perform a function that is not provided in the HSM firmware. In the example of FIG. 2A, the container 203 is provided for executing a user-defined program. This allows a user access to increased functionality, whilst limiting exposure of the HSM 11. In particular, since the user-defined program is executed in the container 203, the runtime environment of the user-defined program is isolated from the HSM firmware 204 which has access to the security world data 205, thereby improving security.

FIG. 2B shows a container-based virtualisation stack according to an example. In particular, FIG. 2B shows an Operating System kernel 302 running on the HSM hardware 301 (e.g. as depicted in FIG. 1). The OS kernel 302 runs the container engine 202, the launcher service 210, and the main application 204 (HSM firmware) as separate processes. In the examples described below, the Operating System (OS) is a Linux Operating system.

The container engine 202 runs the container 203. The container 203 comprises the user process(es) (defined by respective items of user code) and the supporting files for these processes. In the example of FIG. 2B, the runtime environment of the container 203 is isolated from the runtime environment of the HSM firmware 204. Various known container engines may be used. Examples of container engines include Docker, Linux LXC and Linux LXD.

As has been described previously, the container 203 is associated with a configuration file 207, which is stored separately to the container image 201 in this example. The configuration file 207 defines one or more of: 1) how the network is virtualized in the container (e.g. which of the host's network interfaces are accessible to the runtime environment of the container); 2) a system call filter (e.g. which controls the system calls that can be made by a program executing in the container); 3) the Linux Capabilities available to the program executing in the container (e.g. controlling whether access is provided to specific kernel resources that were previously unavailable to unprivileged processes); and 4) the hardware devices mounted in the OS file system that can be accessed (e.g. for read or write) by the programs executing in the container 203. The system may support multiple substantially-identical containers concurrently, each processing different requests associated with different container images 201.

A simplified schematic form of FIG. 1 is shown in FIG. 2C. Upon a user transmitting to the HSM a request to execute a program, the launcher service 210 initiates the container 203 based on the configuration file 207. The container 203 executes the program while communicating with the container engine 202 and the HSM firmware 204.

One approach is to initialize all containers for running user-defined code according to a default whitelist of system calls, devices, and capabilities, which is the same for all initialised containers. The whitelist corresponds to a default configuration file stored on the HSM. For example, the whitelist contains the system calls, devices and capabilities that are deemed to be “safe” by a system administrator.

However, this whitelist may be too permissive for a user's specific use case. For example, although the number of system calls that can be made may be reduced to around 100 in the default whitelist, even this reduced set of 100 system calls may be too permissive for some use cases.

In the following description, there is provided a method for executing a user-defined program in the HSM 11 that specifically controls the configuration of the container based on configuration information associated with a user.

A first aspect of the disclosure is a computer-implemented method comprising:
a. receiving from a user a request to execute a program;
b. selecting a certificate from a certificate database which stores a plurality of certificates, each certificate being configuration information for defining an isolated execution environment and different ones of the certificates being different configuration information;
c. extracting the selected certificate;
d. initializing an isolated execution environment based on the configuration information of the extracted certificate; and
e. executing the program in the isolated execution environment.

Different ones of the certificates are (that is, specify) different configuration information. Thus, the configuration of an isolated execution environment can be tailored by the selection of one of the certificates, e.g. so that an isolated execution environment can be different for ones of the users and/or for requests of different types. This provides a convenient way of controlling selective access to the HSM, and optionally to other resources via the HSM.

In one option, one or more of the certificates stored in the certificate database may be associated with corresponding ones of a plurality of users (i.e. there is a mapping between certificates and users), and the selected certificate is selected as a certificate associated with the user from whom the request was received. Thus, requests from different users may conveniently be processed using differently configured isolated execution environments. The mapping may be defined by association data (e.g. stored in the certificate database). Note that under the mapping, a given one of the users may be associated with multiple ones of the certificates (as described below) and a given one of the certificates may be associated with multiple ones of the users.

For example, different users may be trusted to different respective levels, e.g. specified by the association data. A user who can be trusted (e.g. not to provide program requests which present security risks) may be associated with certificate(s) which give the corresponding isolated execution environment greater freedom than the certificate(s) of another user (i.e. user who is associated with a lower level of trust than the first user).

In another example, different users may be associated with different professional roles (e.g. within an organization). A user who typically performs tasks which require greater access to the resources of the HSM may have certificate(s) which give the corresponding isolated execution environment greater freedom than the certificate(s) of a user who requires more limited access to the resources of the HSM.

Optionally, associations between users and certificates made, e.g. by an administrator of the system updating the association data, in response to a payment, e.g. a payment to an owner of the HSM by the user (or an organization with which the user is associated). Thus, the associations may at least in part reflect payment levels (e.g. sums of money) which the users have paid.

In general terms, the certificates may define access to any resources of the computer system itself, or at any devices outside the computer system. In this way, the resources/devices may be shared between multiple users, according to proportions defined by the certificates associated with each of the user. Each user may be associated with a different corresponding isolated execution environment which is initialized, following a request from that user, based on a certificate associated with that user and extracted from the certificate database. The multiple isolated execution environments may run on the computer system in parallel, i.e. with operations of different ones of the execution environments being performed substantially simultaneously by a processor of the computer system which is capable of parallel processing, or with operations of the multiple isolated execution environments being interleaved.

For example, a certificate may indicate that the isolated execution environment may use a CPU (or other processor device) of the computer system but with an operation rate limit, e.g. specifying that the number of operations performed by the processor device in a given time (“unit time”) has an upper limit. Alternatively or additionally, it may specify a memory usage limit for a memory of the computer system and/or of a memory device external to the computer system.

The limit(s) may be fixed, or may be conditional. For example, they may depend upon whether other isolated execution environments are currently running on the computer system. For example, each certificate may be associated with a CPU usage priority value, and, at any given time, the operation rate limit for each isolated execution environment may be a function of the CPU priority values of all the isolated execution environments which have been initiated and have not yet been deactivated. In another example, each certificate may be associated with a memory usage priority value, and, at any given time, the memory usage limit for each isolated execution environment may be a function of the memory usage priority values of all the isolated execution environments which have been initiated and have not yet been deactivated.

The certificate may alternatively or additionally specify permitted system calls and/or permitted device calls which the isolated execution environment is permitted to make, to access functionality of the computer system or external device(s).

For example, the configuration information of each certificate may specify whether a hardware implementation of at least one of an encryption algorithm, a key exchange protocol and a signature algorithm can be accessed.

Alternatively or additionally, the configuration information of each certificate may specify whether a software implementation of at least one of an encryption algorithm, a key exchange protocol and a signature algorithm can be accessed.

Typically, the request to execute the program defines one or more requirements for the operation. For example, it may define explicitly any one or more of a CPU usage limit (i.e. a maximum number of operations per unit time the program must be able to access), memory usage limit (i.e. a maximum amount of memory to which the program must have access), and/or system/device calls which must be available. Alternatively, these may be implicit from the program (e.g. the program may include certain device calls or include routines which will generate data of a certain size to be stored).

Optionally, e.g. before initializing the execution environment, the computer system may include a compatibility determination process for determining whether at least one requirement defined by the request is compatible with the certificate(s) in the certificate database associated with the user from whom the request was received. This option is particularly valuable in cases in which the operation of the isolated execution environment during the execution of the program is not monitored (see below). If the determination is negative, an error resolution process may be initiated, e.g. an error message may be transmitted to the user. In the case of a user associated with multiple certificates, the compatibility determination process may determine if any of those certificates is compatible with the at least one requirement, and only perform the error resolution process if none of the certificates is compatible with the at least one requirement. Optionally, the compatibility determination process may not be performed, e.g. it may initially be assumed that the requirements of the request are compatible with the certificate(s) associated with the user, at least until monitoring of the isolated execution environment shows that this is not the case.

As noted, optionally one or more of the users may be associated with multiple ones of the certificates, specifying different respective configuration information. Upon receiving a request from a user associated with multiple certificates, a certificate is selected from the multiple certificates associated with the user (e.g. from among one or more certificates associated with the user which are determined to be compatible with at least one requirement defined by the request). The isolated execution environment is then initiated based on the selected certificate.

The selection of the certificate may be at least partly based on the request itself (e.g. so that the certificate selected is the one which is most appropriate to one or more requirements defined by the request). For example, the certificate may be selected (e.g. from among the certificates associated with the user who transmitted the request and which were determined to be compatible with at least one requirement defined by the request) as a configuration which, according to a certain selection criterion, is best suited to execute the program. For example, it may be selected as the certificate which exceeds a requirement defined by the request by the smallest amount.

Alternatively, the certificate may be specified explicitly by the request (e.g. by including a certificate index number labelling the certificate in the certificate database), or may be selected according to a predefined certificate preference of the user. For example, the user may define an order for the certificates, and the certificate may be selected as the first certificate in that order, e.g. the first certificate which is compatible with the at least one requirement defined by the request.

The operation of the initiated isolated execution environment to execute the program may be monitored. Upon determining that system resources employed by an isolated execution environment exceeds at least one threshold (e.g. one of the limits discussed above defined by the configuration file/certificate, or a slightly higher or lower value), the computer system may interrupt the execution of the program to ensure that the execution of the program meets the limits defined by the extracted certificate.

Optionally, the computer system may be operative to modify the certificate database. For example, the computer system may be operative to add/remove a certificate to the certificate database. For example, upon a user purchasing the right to use the computer system (e.g. for a certain time) within certain limits, the association data may be modified to associate a certificate defining those limits with the user. Conversely, upon a user losing the right to use the computer system (e.g. upon a certain time period expiring), the association between the certificate and the user may be removed.

In another example, the computer system may be operative to modify a certificate stored in the certificate database, e.g. upon receiving an instruction from an administrator to do so. In the case of a certificate which has already been extracted and used to initialize an isolated execution environment which has not yet terminated, upon the extracted certificate being modified the isolated execution environment may be modified correspondingly. This provides a convenient way for an existing isolated execution environment to be modified.

According to another aspect, there is provided a carrier medium comprising computer readable code configured to cause a computer to perform any of the above methods.

According to another aspect, there is provided a non-transitory computer readable storage medium comprising program instructions stored thereon that are executable by a computer processor to perform any of the above described methods. The methods are computer-implemented methods. Since some methods in accordance with embodiments can be implemented by software, some embodiments encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal. The carrier medium may comprise a non-transitory computer readable storage medium. According to a further aspect, there is provided a carrier medium comprising computer readable code configured to cause a computer to perform any of the above described methods.

According to another aspect, there is provided a device, comprising one or more processors configured to: obtain configuration information for an isolated execution environment; obtain a program; initialise an isolated execution environment based on the configuration information; and execute the program in the isolated execution environment.

In one example, the device is a hardware security module device. For example, the device may be a hardware security module device as illustrated by FIG. 1. The logical structure of the hardware security module may be as illustrated in FIG. 3. This is a similar logical structure to the one shown in FIG. 2A. However, the HSM 11 with the logical structure of FIG. 3 further contains a certificate database 208 storing multiple certificates associated with corresponding ones of a plurality of users. The certificate database 208 may further store association data defining an association (mapping) between users and certificates, as described below with reference to FIG. 7. The certificate database 208 may be stored in the non-volatile memory 105 in FIG. 1.

Each certificate in the certificate database may be associated with a signature dataset generated from the certificate using a key. The signature dataset may be checked when the certificate is downloaded into the certificate database 208, i.e. a check is performed that the signature dataset meets a validity criterion. The validity criterion may comprise a requirement that the signature dataset was generated from the associated certificate using the key. The signature dataset may further specify a validity period, and the validity criterion may include a check that the validity period has not yet expired.

As described below, upon receiving a request from a user to execute a program, one of the certificates can be selected and extracted by the launcher service 210. Optionally, the launcher service 210 may check the signature dataset associated with the extracted certificate (i.e. according to the validity criterion). This check may include checking that the associated validity period has not expired. If the check is not successful, the launcher service may generate an error message, and the process may terminate.

If the check is successful (or if there is no check), the launcher service 210 forms one of the configuration files 207 from the extracted certificate.

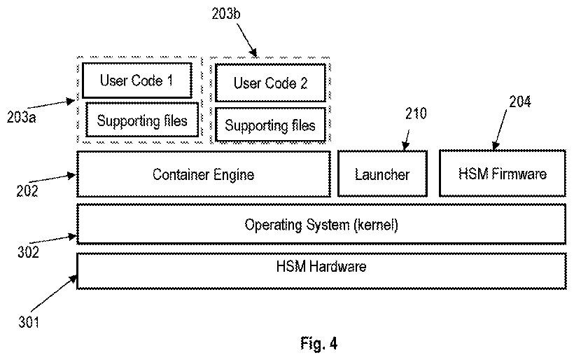

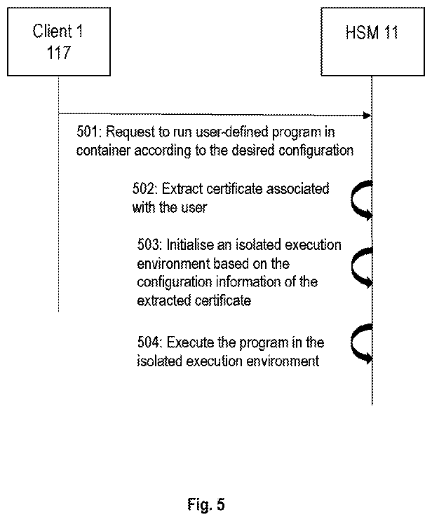

The virtualization stack for the HSM with the logical structure of FIG. 3 is shown in FIG. 4. Instead of the single container 203 of FIG. 2B, in the HSM 11 of FIG. 3 the visualization stack shows two containers 203a, 203b associated with two respective users (“user 1” and “user 2”). Although just two containers 203a, 203b for just two corresponding users are shown, there may be any number of containers corresponding to different users. In the case of a user who causes multiple requests to be transmitted to the HSM to execute programs, the requests may generate multiple containers which exist concurrently, e.g. according to corresponding ones of the certificates (e.g. the same certificate for all the containers, or different certificates for different ones of the containers).

The containers 203a, 203c exist concurrently (i.e. a period is shown after both containers 203a, 203b have been initiated and before either is terminated (deactivated or deleted)). Each container 203a, 203b contains at least one corresponding program (“user code 1” and “user code 2”) and optionally supporting file(s) for the program. Each of the containers 203a, 203b is initiated based on a corresponding configuration file/certificate, which may be a certificate associated with the corresponding user. The configuration files/certificates for different users may be different or the same.

As in FIG. 2B, the Operating System kernel 302 of FIG. 4 runs on the HSM hardware 301. The OS kernel 302 runs the container engine 202, the launcher service 210, and the HSM main application 204 (HSM firmware) as separate processes. In the examples described below, the Operating System (OS) is a Linux Operating system. The container engine 202 runs the containers 203a, 203b. The runtime environment of the containers 203a, 203 are isolated from each other and from the runtime environment of the HSM firmware 204, e.g. such that data cannot pass between them. Various known container engines may be used. Examples of container engines include Docker, Linux LXC and Linux LXD.

Returning to FIG. 3, a request from a first user (e.g. user 1) to the HSM 11 to execute a program comprises a container image 201. Once received, the container image 201 is stored (e.g. by the launcher service 210) in the non-volatile memory 105 of the HSM 11. The container image 201 comprises program code corresponding to the programs to be run in the container. The container image 201 further comprises all libraries, supporting files and programs, and any language interpreter required to run these programs on the HSM 11.

In response to the request, the launcher service 210 selects a certificate from the certificate database 208 and extracts it. For example, the launcher service 210 may select the certificate (e.g. associated with of the first user according to the association data), as a certificate associated with the first user. The launcher service 210 stores the certificate as a configuration file 207a. Optionally, the launcher service may perform the check described above using an associated signature dataset; if so, it is assumed here that the check is met. The launcher service 210 initiates (launches) and runs a container 203a by sending an instruction to the container engine 202 to initiate a container 203a according to the container image 201 and a configuration file 207a. When the container 203a is running, the programs may run without requiring access to files outside the container 203a.

The same process is conducted when a second user (say user 2) transmits a request to the HSM 11 to execute a program. In this case, the launcher service 210 extracts a certificate (e.g. associated with the second user according to the association data), and stores it as a configuration file 207b. The launcher service 210 initiates (launches) and runs a container 203b by sending an instruction to the container engine 202 to initiate a container 203a according to the container image 201 and a configuration file 207b.

The configuration files 207 a, 207 b define one or more of: 1) how the network is virtualized in the corresponding container 203a, 203b (e.g. which of the host's network interfaces are accessible to the runtime environment of the container); 2) a system call filter (e.g. which controls the system calls that can be made by a program executing in the container); 3) the Linux Capabilities available to the program executing in the container (e.g. controlling whether access is provided to specific kernel resources that were previously unavailable to unprivileged processes); and 4) the hardware devices (e.g. a quantum entropy source for random number generation) mounted in the OS file system that can be accessed (e.g. for read or write) by the programs executing in the container 203a, 203b.

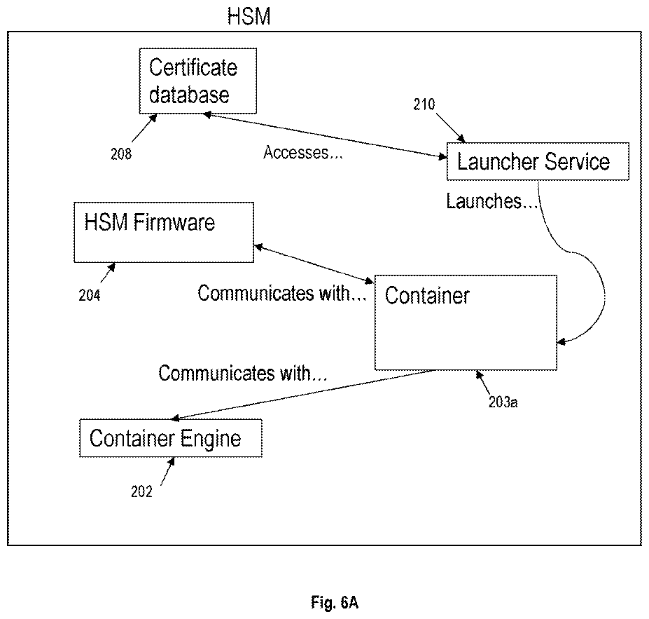

FIG. 5 shows a method performed by a system comprising a HSM 11 and a client device 117 according to the example of the disclosure. The client device 117 corresponds to a user of the HSM device 11. Here we assume that it is user 1, but the process would be equivalent for a different user. The client devices for other user(s) of the HSM device 11 are not shown. As has been described previously, the client device 11 may be a computing device such as a desktop or laptop computer, or mobile device for example. As described previously, the HSM 11 may be directly coupled to the client computing device 117. Alternatively, the HSM 11 is located in a host system which is separate to the client computing device 117 and communication performed through the host system. The HSM 11 may be a HSM as has been described in relation to FIG. 1 and FIG. 3 for example.

In step 501, the client 117 the client 117 transmits a request to the HSM 11 to execute a program. The request comprises a container image. In an alternative example, the request comprises a reference (e.g. an address in memory or a file name) associated with a container image stored on the HSM 11.

In either case, the container image comprises a user-defined program. The container image further comprises all libraries, supporting files and programs, and any language interpreter required to run these programs on the HSM 11. The user therefore provides a container image including the user's program, any required files, and any binaries that that user's program depends on. The container image comprising the user-defined program may be provided from the client device 117 to the HSM 11 using various mechanisms. For example, EP3952202—A DEVICE AND A METHOD FOR PERFORMING A CRYPTOGRAPHIC ALGORITHM, the entire contents of which are incorporated by reference herein, describes an example method of providing computer program code embodying a desired algorithm in an input data packet.

The request may be communicated between the client 117 and the HSM 11 over a secure channel to mitigate against tampering (e.g. by encrypting the desired container configuration at the client 117 in a way that can be decrypted by the HSM 11). In an example, the first secure channel uses the SSH protocol.

In step 502, the launcher service 210 of the HSM 11 selects a certificate from a certificate database and extracts it. In one option, the HSM firmware 204 identifies user 1 from the request, and the launcher service 210 extracts from the certificate database a certificate associated with user 1. This process is described in more detail below, including a case in which there are multiple certificates associated with user 1. Optionally, the launcher service may perform the check described above using an associated signature dataset. It is assumed here that the check is met; if not, the method terminates. The certificate is container information which specifies a desired container configuration. The container information is stored as a configuration file 207a. In an example the information indicating the desired container configuration comprises one or more of: 1) devices of the HSM 11 that are to be made accessible to the container, 2) capabilities of the container (e.g., an indication of the root privileges available to a process executing in the container), 3) an indication of the system calls that are to be supported by the container (e.g. the OS system calls that can be made by the process in the container and actioned by the kernel), and/or 4) whether the container is to have internet connectivity.

In step 503, the launcher system 210 initializes a container 203a that is configured according to desired container configuration obtained in step 502.

In step 504, HSM 11 executes the program in the container image within the container 203a.

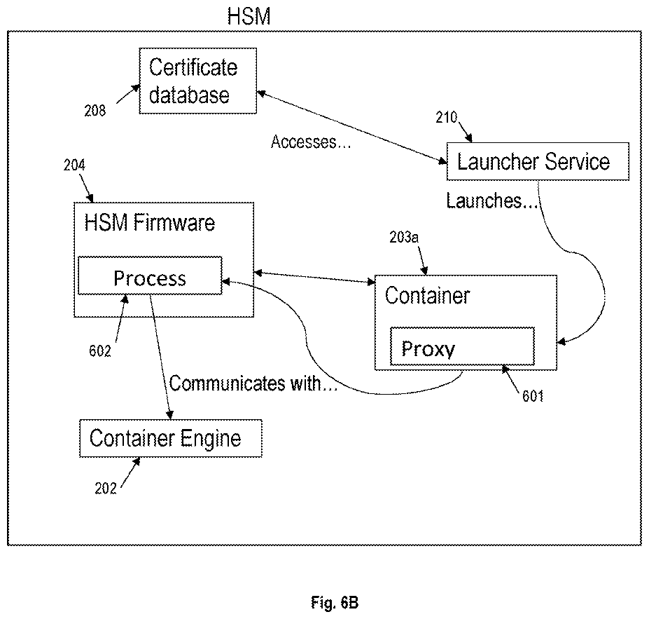

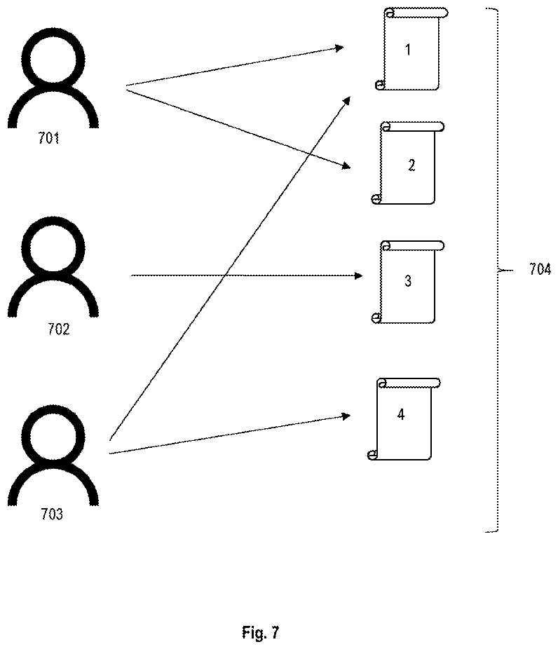

FIG. 6A is a schematic illustration of a first manner of operation of an HSM 11 with the logical structure of FIG. 3. Upon a user transmitting to the HSM 11 a request to execute a program, the launcher service 210 accesses a certificate database 208 and extracts a certificate from the certificate database 208. Optionally, the launcher service may perform the check described above using an associated signature dataset. It is assumed here that the check is met; if not, the method terminates. The extracted certificate forms a configuration file. In the case that the request is from user 1, the configuration file is configuration file 207a. The launcher service 210 initiates the corresponding container 203a based on the configuration file 207a. The container 203a executes the program while communicating with the container engine 202 and the HSM firmware 204. The communication with the HSM firmware may use an API defined by the HSM firmware.

FIG. 6B is a schematic illustration of a second manner operation of an HSM with the logical structure of FIG. 3. This differs only by how the container 203a communicates with the HSM firmware. Specifically, in the operation shown in FIG. 6B the container 203a is provided with a proxy (proxy server) 601, an item of software which filters communications between the container 203s and other applications running on the operating system 302. In particular, the proxy server 601 can be arranged to communicate with a process 602 executed by the HSM firmware 204. Communications between the container engine 202 and the container 203a can be via the proxy 601 and the process 602. The process 602 may be a “daemon”, a program executing as a background process.

Turning to FIG. 7, associations are shown between a plurality of users 701, 702, 703 and a plurality of certificates 704 stored in the certificate database 208. In this example, the certificate database stores four certificates, labelled by certificate index numbers 1 to 4. The user 701 is associated with the certificates labelled 1 and 2. The user 702 is associated with a single certificate, which is the one labelled 3. The user 703 is associated with certificates labelled 4 and 1. Note that both users 701 and 703 are associated with the certificate labelled 1.

The associations are defined by “association data” stored in a mapping table. The mapping table may be stored in the certificate database 208. The association data shows, for each of the users, which of the certificates 704 each of the users is associated with. Thus, upon consulting the mapping table, the HSM 11 (e.g. the HSM firmware 204) can determine which certificate(s) are associated with a given user. For example, the HSM can determine that the user 703 is associated with the certificates labelled 1 and 4.

The mapping table may further contain information which is used, upon a request being received from a user to execute a program, to select one of multiple certificates associated with the user. That is, the mapping table may indicate a predefined certificate preference of the user. For example, the mapping table may define an order for the certificates for a given user such that, when a request is received from that user, one of the certificates associated with that user can be selected as the certificate which is first in the order, and which optionally meets at least one additional criterion. As discussed below, the additional criterion may be that the certificate is compatible with at least one requirement defined by the request.

In principle a user who is not associated with any of the certificates may be submit a request to execute a program. The certificate database 208 may store at least one default certificate for such a user. One of the default certificate(s) is selected when such a user submits a request to execute a program.

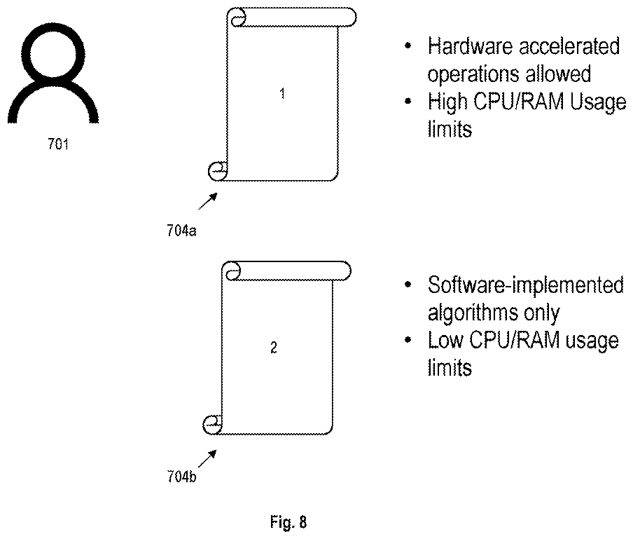

FIG. 8 shows a portion of FIG. 7 in more detail, and in particular shows the configuration information for the two certificates 704a, 704b (the ones with certificate index numbers 1 and 2) associated with user 701. The certificate 704a contains configuration information which defines an isolated execution environment which is allowed to access hardware accelerated operations of the HSM (i.e. operations which are implemented on the HSM 11 in hardware rather than software), and which has relatively higher CPU/RAM usage limits. The certificate 704b contains configuration information which defines an isolated execution environment which is not allowed to access hardware accelerated operations of the HSM, but is allowed to access software-implemented algorithms performed by the HSM firmware 204. Furthermore, the configuration information for the certificate 704 has relatively low (i.e. lower than the certificate 704a) CPU/RAM usage limits.

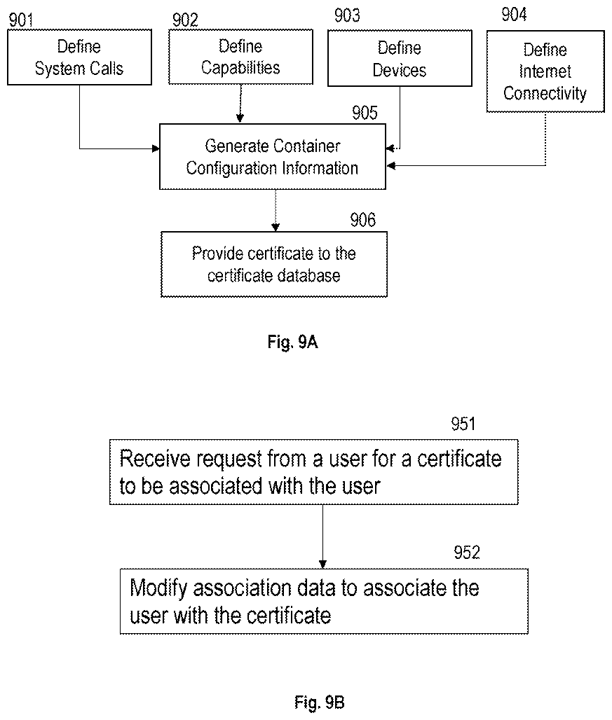

FIG. 9A shows a method of defining a certificate 704. The method may be performed by a supplier of the HSM 11, or by an owner or administrator of the HSM 11. It may be performed in the HSM 11 by transmitting commands to the HSM 11 (e.g. through the interface 107) but may alternatively be performed using a separate computer system, for example one having a graphical user interface and data entry devices. The method comprises performing one or more of step 901, step 902, step 903, and/or step 904 in any order; and then performing step 905 and optionally step 906.

As discussed above, in an example the container configuration information comprises one or more of: 1) devices of the HSM that are to be accessible to the programs executing in the container; 2) the Linux capabilities that are accessible to programs executing in the container; 3) the system calls that can be made by programs executing in the container and/or 4) whether the programs executing in the container have internet access.

In step 901, the method comprises defining (e.g. by manual data input) the system calls that are to be made available to the processes (e.g. the user-defined program) running in a container defined by the certificate. A system call is a programmatic way in which a computer program requests a service from the kernel of the operating system. All computer programs that use computer resources use system calls. System calls are used for process creation, process management, memory management, networking, device I/O handling etc. Linux system calls include: fork(), exit( ), exec( ), open( ), read( ), write( ), close( ) etc.

In step 902, the method comprises defining the Linus capabilities of processes accessible to programs executing in the container (e.g. by manual data). For example, the administrator can manually type the desired capabilities into a file containing the container configuration information. This may include setting one or more limits, including a CPU usage limit and/or a RAM usage limit, and/or a permitted power usage limit. Instead of or in addition to the power usage limit, step 902 may include defining a priority value. Note that the permitted power usage limit may be set individually, or it may be implicit, i.e. a function of other limits set in step 902, e.g. the CPU usage limit and/or the RAM usage limit.

In step 903, the method comprises defining the devices of the HSM that are to be accessible to the container (e.g. by manual user input).

In step 904, the method comprises defining the internet connectivity status of programs executing in the container. In an example the internet connectivity status comprises an indication of whether or not internet connection is permitted (e.g. Internet connection =yes/no). In this example, the supplier/administrator/owner has a binary option “internet connectivity: on/off”, where the latter specifies that program is run “offline” -in this case no network connectivity features are available.

Steps 901, 902, 903, and 904 are shown in parallel in FIG. 9A, and these steps may be performed independently of each other. However, as has been described previously, the steps may overlap. Furthermore, in some examples, one or more of steps 901, 902, 903 and 904 are performed without all of steps 901, 902, 903 and 904 being performed. In this case, the steps performed will determine the extent to which the configuration of the container on the HSM is controlled. For example, in the case where only step 901 is performed, then the container functionality would only be limited (further than a default configuration) in terms of the system calls that can be made by the program executing in the container.

After performing one or more of steps 901, 902, 903 and 904, the method proceeds to step 905.

Step 905 comprises generating container configuration information. In this example, step 405. Step 905 comprises generating a file comprising a representation comprising the system calls, the capabilities, the devices, and/or the internet connectivity status (depending on which of steps 901-904 are performed). In an example generating the desired container configuration information comprises combining one or more of: the system calls defined in step 501, the capabilities defined in step 902, the devices defined in step 903, and/or the internet connectivity status defined in step 904 into a single list.

In step 906, the configuration information is provided to the certificate database 208 as a certificate. For example, if the steps 901-905 are performed using a computer system external to the HSM 11 the configuration information may be transmitted to the certificate database 208 via the interface 107 and the HSM firmware 204. Note that in embodiments in which steps 901-905 are performed using the HSM 11 itself (e.g. defining the new certificate in the non-volatile memory 105) no separate step of transferring the configuration to the certificate database may be needed; that is, steps 901-905 may define the certificate within the certificate database 208.

Step 906 typically comprises providing the certificate with a certificate index number which may be used to reference the certificate.

The process of FIG. 9A may be performed multiple times, to define multiple certificates within the HSM 11. For example, steps 901-905 may be performed using an external computer system to define multiple certificates, and then step 906 may be performed for each of the certificates to upload it into the certificate database 208. Optionally, the method of FIG. 9A may be performed again later (e.g. after the HSM 11 has already executed some programs the process shown in FIG. 3) to increase the number of certificates in the certificate database 208.

FIG. 9B shows the steps of a method for defining the association data. This step may be performed after the method of FIG. 9A, though in principle it may be performed before it.

In a first step 951 an administrator receives a request to associate a user with at least one of the certificates of the certificate database 208. This request may identify the certificate(s) with which the user wishes to become associated, e.g. using the corresponding certificate index number(s). The user may be an individual or organization which is not currently associated with one of the certificates (a “new user”) and wishes to become associated with one or more of the certificates, or a user who is already associated with one or more of the certificates (an “existing user”) and wishes to become associated with one or more certificates. In either case the new/existing user is typically aware (at least to some extent) of the capabilities of the certificate with which it requests to be associated. The request to associate the user with the certificate(s) may optionally include or reference a payment the new/existing user makes to the administrator or another organization.

Following a check that the new/existing user meets one or more conditions (e.g. relating to the identity of the new/existing user, and/or the payment being adequate), in step 952 the administrator may determine to associate the new/existing user with the certificate specified in the request to associate the user with at least one of the certificates. The administrator does this by transmitting into the HSM 11 a command to modify the association data stored in the certificate database to associate the new/existing user with the certificate(s) requested.

FIG. 10 shows a process performed by the HSM using the certificates and the association data. That is, it shows the process of FIG. 5 from the point of view of the HSM 11 of the processes of FIG. 5. The method may be performed by a HSM 11 as has been described previously for example with reference to FIG. 1 and FIG. 3. The HSM 11 stores program code (e.g. in non-transitory memory) that implements the steps 1001-1005 of FIG. 10-for example, the method of FIG. 10 is performed by the HSM firmware 204 and the launcher service 210.

In step 1001 of the method of FIG. 10, the method comprises receiving from a client device 117 (i.e. from a user) a request to execute a user-defined program. The request comprises the container image comprising the user-defined program and further comprises all libraries, supporting files and programs, and any language interpreter required to run these programs on the HSM 11. It further identifies the user who transmitted the request. It may do this by including a user token (e.g. an encrypted token) which the HSM 11 may compare to a database of user tokens.

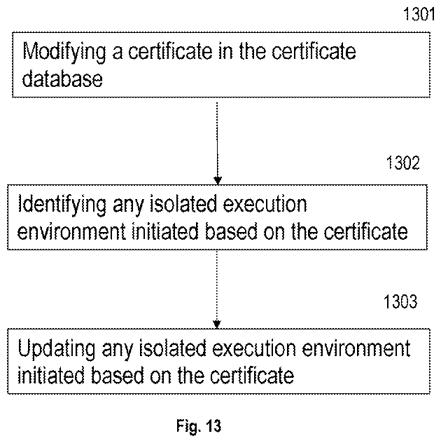

In step 1002, upon receiving the request, the HSM 11 selects one of the certificates. Specific methods for conducting this step are explained below with reference to FIGS. 10 and 11.

In step 1003 the selected certificate is extracted from the certificate database 208 by the launcher service 210. Optionally, the launcher service may perform the check described above using an associated signature dataset. It is assumed here that the check is met; if not, the method terminates.

In step 1004 a container is initialized, by the container engine 202 under the control of the launcher server 210, according to the container configuration information of the selected certificate extracted in step 1003.

Initializing the container comprises the launcher service 210 generating a container configuration file that includes the system calls, devices and/or capabilities specified in the selected certificate. Without loss of generality, we assume that the user is the “user 1”, so that the container is denoted 203a (as in FIG. 3 and FIG. 4) and the configuration file is denoted 207a. In an example, the generated container configuration file 207a comprises only the system calls, devices and/or capabilities specified in the container configuration information defined by the selected certificate (optionally as well as other configuration information). Generating a container configuration file 207a may comprise modifying a template container configuration file for example. The template container configuration file may be a default container configuration file. The launcher service 210 may store the configuration file 207a, e.g. in the working memory.

For example, the launcher service 210 may generate a seccomp profile that specifies the allowed system calls. The launcher service 210 includes the seccomp profile in the container configuration file 207a. This may involve modifying an LXC container configuration file to use the generated seccomp profile. The LXC container configuration file may also be modified to also only allow the enabled devices specified in the custom configuration information. For example, this may involve using cgroups a Linux kernel feature. The LXC container configuration file may also be modified to according to the requested network configuration information.

The configuration file 207a is then provided to the container engine 202 (e.g. the container engine 202 is instructed by the launcher server 210 to read the configuration file 207a from memory, e.g. the working memory). The syscalls, capabilities, devices and network availability are managed by the LXC container engine, where the LXC container engine calls the right functions from the OS kernel 302 to set the container up. For example, the container engine 202 generates a seccomp filter according to the seccomp profile in the configuration file 207a.

Once initialised according to the configuration, in step 1005 the user program is executed in the container with the allowed syscalls, capabilities and devices, e.g. in a conventional manner. This is based on the container image 201 for the corresponding program.

The execution of the program may be monitored to ensure that it is according to requirements defined by the selected certificate. For example, if the number of CPU operations (e.g. per unit time) or memory usage is determined to exceed a threshold defined by the certificate, the execution of the program may be terminated, and an error message sent to the client device 117.

It will be understood that defining the container according to one of the certificates 704 increases the system security. For example, restricting the system calls that can be made by a user-defined program within the container to be one of the certificates 704 reduces the attack surface with which a user-defined program can attack the kernel and exploit the data (e.g. cryptographic keys) and the operation of the HSM 11. In particular, the attack surface is reduced when the container configuration is restricted to only those system calls that are required by a user-defined program because the number of permitted system calls is reduced and the ability of a malicious party to launch an attack on the kernel from within the container (e.g. by replacing the user-defined program with a malicious program) is mitigated since the container will only allow system calls that are used by the user-defined program.

FIG. 11 shows a first way of implementing step 1002 the method of FIG. 10. In an example the method of FIG. 11 is implemented by a HSM 11, e.g. as shown in FIG. 1 and FIG. 3.

In step 1101 the method comprises identifying, using the association data stored in the certificate database, one or more certificates stored in the certificate database 208 associated with the user who transmitted the request. In the case of user who is not associated with any certificates, at least one default certificate may be selected.

If multiple certificates in the certificate database 208 are associated with the user who transmitted the request (or if, in the case of a user who is not associated with any certificates, there are multiple default certificates), the method of FIG. 11 comprises a step 1102 of selecting one of those certificates. There are several ways this could be done.

In one option, the selection may be based on at least one requirement defined by the request for the program to be executed. For example, the request many specify a certain maximum number of transactions per second is performed (e.g. by the CPU 103, or by another device). For example, the request may define a CPU usage limit. This may be defined explicitly in the request or be implicit from properties of the program. A certificate may be selected which specifies a CPU usage limit which is greater than the CPU usage limit specified by the request by the least amount (i.e. the selected certificate may be selected such that the CPU usage limit specified by the selected certificate minus the CPU usage limit specified by the request, is positive but as small as possible). In this way, a container is chosen which gives the least risk of an unacceptable amount of CPU being used, either by the user-defined code malfunctioning or if the user-defined code has been compromised by a malicious third party. If the request does not specify a CPU usage limit then a certificate may be selected which also does not, or which has a high CPU usage limit.

Although this example is based on selecting a certificate based on CPU usage limits, in variations the selection may be based on a memory usage limit, or a combination of multiple usage limits.

Alternatively, the selection in step 1102 could be done based on data (e.g. included in the mapping table or included in the request) indicating a predefined certificate preference of the user. This may indicate an order for the certificates. Step 1102 may then include selecting the certificates as the first certificate in the preferred order defined by the data, out of the certificates identified in step 1101.

Note that in a variation, step 1101 could be omitted, and step 1102 could be performed in respect of all the certificates in the certificate database 208. In this variation the association data would be not be needed and the mapping shown in FIG. 7 would not exist. This would still have the advantage that the most appropriate certificate for the job is selected, potentially leading to greater efficiency (e.g. by selecting a container configuration which has sufficient flexibility to implement the request) while not having unnecessary flexibility (leading to a greater security risk). However, it would mean that that selected certificate is not generally associated with the user who transmitted the request, so the selection of container capabilities according to which user transmitted the request would not be present.

FIG. 12 shows an alternative way of implementing step 1002 of the method of FIG. 10. Steps 1201 and 1204 correspond to, and are identical to, steps 1101 and 1102 of the method of FIG. 11 respectively. However, the method of FIG. 12 contains additional steps 1202 and 1203.

In step 1202 the method comprises a compatibility determination process for determining whether any of the certificate(s) determined in step 1201 to be associated with the user who transmitted the request for the program to be executed is compatible with at least one requirement defined by the request. For example, the configuration file may be examined to determine whether 1) the devices of the HSM that are required to be accessible to the program; 2) the Linux capabilities that are required to be accessible to the program; 3) the system calls that are required to be available to the program and/or 4) the program requires internet access. These requirement(s) are compared with the certificates determined in step 1102, to see if any matches.

If it is determined in step 1202 that none of the certificate(s) associated with the user from whom the request was received is compatible with the requirement(s) of the request, in step 1203 an error resolution process is performed. For example, the HSM 11 may transmit an error message to the client system 117, informing the client 117 that the request to execute the program is unsuccessful. The method of FIG. 12 may then end (i.e. the program is not executed). In this case the user may take action, e.g. by modifying the program or by transmitting a request to an administrator for the user to become associated with another certificate (e.g. one which places fewer constraints on the isolated execution environment it defines). Alternatively, the error resolution process 1203 may comprise modifying the configuration file to be compatible with one of the constraints. For example, if the requirement is that the program is permitted to control the CPU 103 to perform a certain number of operations in unit time, and that requirement exceeds CPU usage limit(s) specified by the certificate(s) identified in step 1201, the configuration file may be modified so that the program can be run, but more slowly. In this case, the method of FIG. 12 may be performed again, and the second time the method may advance to step 1204 (that is, if multiple certificates were determined to be compatible in step 1202, determining which certificate is most appropriate for the job) using the modified configuration file. Note that in the case that step 1204 is performed by reference to requirement(s) of the program, as explained above with reference to step 1102, the requirements used in step 1204 may be different from those used in step 1202, e.g. fewer requirements may be used in step 1204 than in step 1202.

As explained above, although it is preferable for users to be associated with certificates as shown in FIG. 7, this is not essential. In this case, the methods of FIGS. 11 and 12 may omit steps 1101 and 1201 respectively. That is, steps 1102 and 1202-1204 can be performed for all certificates in the certificate database 208.

FIG. 13 shows a method of dynamically updating a container configuration according to an example.

In step 1301 a certificate stored in the certificate database 208 is modified. This may be done because a vulnerability of container configurations according to the certificate has been identified. In some cases it may become apparent that one or more configuration settings (e.g. system calls, devices, capabilities etc.) that was once considered safe and therefore included in one of the certificates 704, is no longer safe, for example, due to a recently identified vulnerability (e.g. a zero-day attack).

The modification may be done, for example, by an administrator or supplier of the HSM 11 transmitting a replacement version of the certificate to the certificate database 208 via the interface 107 and the HSM firmware 208. Alternatively, the administrator/supplier may transmit instructions (e.g. via the interface 107) to the HSM firmware to modify a certificate in the certificate database 208.

In step 1302 it is determined by the HSM 11 whether any container (isolated execution environment) has already been launched based on the certificate before it was modified, and is still in existence (i.e. the program executing in the container has not yet terminated). The launch of the container may have happened days, months or years before step 1301 was performed.

In step 1303, the configuration of the isolated execution environment for any containers identified in steps 1302 is modified.

In a first approach, modifying the current configuration of the container comprises identifying the configuration parameter to be changed and then updating the configuration of the container instance. For example, this may involve using the “lxc config device remove” command to remove a device which was once permitted by the certificate, but now is no longer permitted.

In a second approach, the container instance is paused, the configuration of the container is updated and the container operation is then resumed. In another example the state of the processes in the container is saved, the container is then stopped, and a new container is generated with the saved state and the updated configuration settings.

In some cases, the act of changing the configuration of the container to remove the access to the vulnerable configuration may mean that, at some point, the user-defined program being executed in the container will make an attempt to access the vulnerable resource (e.g. by attempting to access the vulnerable device, or by attempting to use the vulnerable system call). In this case, the container will block such a request and an error will be generated, preventing a user-defined program from potentially exploiting a resource that is known to be vulnerable.

Alternatively, upon determining that the already-initialised container has a configuration that allows access to the vulnerable parameter (e.g. allows access to the vulnerable device or allows the vulnerable system call to be made), and upon determining that the desired container configuration was based on the program being executed in the container, then the container is stopped and removed. In this case, the program being executed in the container is no longer suitable for being executed on the HSM (because it requires access to a vulnerable command/device) and so the container and the program executing in the container is stopped, instead of waiting for an error as in the example above.

The method of FIG. 13 reduces the attack surface available to a user-defined program and enables a more secure HSM 11.

In the examples above, reference is made to a user-defined program, however any program that is intended to be run in the container can be used in the methods described herein, whether or not it is defined by the user that wants to run it on the HSM 11.

In the description above, the techniques are described in relation to a HSM 11 running a Linux Operating System (OS). However, the same techniques can be applied to other Operating Systems.

In the examples above reference is made to a container. As discussed above, a container is a standalone unit of software that packages up code and all its dependencies so the application runs quickly and reliably from one computing environment to another. A container is an example of a sandboxed environment or an isolated environment for execution of a program. Other examples of isolated environments may be used however, for example a virtual machine.

The above described methods include customized restriction of container-based applications, or applications based in other isolated environments. There may be instances where assurance that a user-defined program is being executed in accordance with a regulatory or compliance regime is required. By providing custom configuration settings, a user may have assurance that the program is being executed in accordance with a regulatory requirement. There may be instances where this list is not appropriate however, especially where there are different tenants on the HSM that are operating under different regulatory requirements. By allowing restriction of the configuration of a container based on its use case, for example the regulatory regime it is operating under and the system calls used by the program it is executing, compliance with regulatory requirements may be provided and the attack surface reduced in a scalable way.

In the above described methods, the container is customized according to its use requirements: the launcher service initialises the container according to a configuration file defined by a selected certificate, and the user-defined program is executed within the container. This may provide a secure implementation, with a reduced attack surface, i.e. a reduced opportunity to exploit a vulnerability of the HSM, while executing user code. The policy can also be reconfigured to respond to new threats. The method provides the ability to launch customised containers that restrict the system calls, network devices or capabilities of the container. A user can therefore ensure that the program is being executed in accordance with a regulatory requirement. This reduces the attack surface that a malicious user-defined program could exploit, for example.

Even removing a single kernel system call may provide improved security. For example, profiling the user-defined program may indicate that it does not use a first system call. The container is therefore initialised with a seccomp profile that does not include the first system call. If the program is compromised, an attacker may include functionality in the program that calls the first system call. If executed, this functionality may cause a catastrophic failure to the entire HSM. Reducing the container configuration to remove the first system call thus avoids a full compromise of the HSM, and may result in a more contained compromise of just the user's program for example. The container is a possible source of attacks against the HSM-for example, an attacker might compromise the container to then extract sensitive data, e.g. keys, from the HSM. By controlling the configuration settings of the container, the HSM may be protected from the container.

The methods provide a safe secure execution environment (SEE) using a trusted platform, for example a HSM. In particular, the SEE is isolated from impacting the security functionality of the HSM's trusted computing base. However, the application still benefits from operating within the hardened environment of the HSM.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A computer-implemented method comprising:
receiving from a user a request to execute a program;
selecting a certificate from a certificate database which stores a plurality of certificates, each certificate being configuration information for defining an isolated execution environment and different ones of the certificates being different configuration information;
extracting the selected certificate;
initializing an isolated execution environment based on the configuration information of the extracted certificate; and
executing the program in the isolated execution environment.

2. The method of claim 1, wherein the configuration information of each of the certificates specifies at least one of: a CPU operation rate limit, a memory usage limit, permitted system calls, or permitted device calls.

3. The method of claim 2, wherein the configuration information of each certificate specifies whether a hardware implementation of at least one of an encryption algorithm, a key exchange protocol and a signature algorithm can be accessed.

4. The method of claim 2, wherein the configuration information of each certificate specifies whether a software implementation of at least one of an encryption algorithm, a key exchange protocol and a signature algorithm can be accessed.

5. The method of claim 1, further comprising monitoring the operation of the isolated execution environment, and, upon determining that system resources employed by the isolated execution environment exceed at least one limit defined by the extracted certificate, interrupting or modifying the execution of the program to ensure that the execution of the program meets the at least one limit defined by the extracted certificate.

6. The method of claim 1, in which one or more of the certificates stored in the certificate database is associated with corresponding ones of a plurality of users, and the selected certificate is selected as a certificate associated with the user from whom the request was received.

7. The method of claim 6, wherein the request defines at least one requirement and selecting the certificate comprises:
determining whether the configuration information for any of the certificates associated with the user is compatible with the at least one requirement defined by the request; and
if none of the certificates associated with the user is determined to be compatible with the at least one requirement defined by the request, performing an error resolution process.

8. The method of claim 7, wherein the error resolution process comprises transmitting a message to the user indicating that the request will not be actioned.

9. The method of claim 6, wherein the user is associated with a plurality of certificates, and said extracting a certificate associated with the user from the certificate database comprises selecting the certificate from among the plurality of certificates.

10. The method of claim 1, wherein selecting the certificate from among the certificates stored in the certificate database employs predefined certificate preferences.

11. The method of claim 1, wherein selecting the certificate comprises selecting a certificate based on at least one requirement defined by the request.

12. The method of claim 11, wherein selecting the certificate comprises selecting a certificate which defines an access to a system resource which exceeds a requirement defined by the request by the smallest amount.

13. The method of claim 1, further including modifying the database to modify an existing certificate.

14. The method of claim 13, wherein upon a said modification to the extracted certificate, the isolated execution environment is modified correspondingly.

15. The method of claim 1, wherein each of the certificates is associated with a corresponding signature dataset, the method further including, prior to said initializing of the isolated execution environment based on the configuration information of the extracted certificate, checking that the signature dataset associated with selected certificate meets a validity criterion.

16. A device comprising one or more processors configured to:
receive from a user a request to execute a program;
extract a certificate associated with the user from a certificate database, the certificate database storing one or more certificates associated with each of a plurality of users, each certificate being configuration information for an isolated execution environment;
initialise an isolated execution environment based on the configuration information of the extracted certificate; and
execute the program in the isolated execution environment.

17. The device of claim 16, wherein the device is a hardware security module device.

18. The device of claim 17, wherein the database of certificates is stored in the hardware security module.

19. A computer-readable medium comprising computer-executable instructions stored thereon which, when executed by a processor of a computing system, cause the computing system to perform:
receiving from a user a request to execute a program;
selecting a certificate from a certificate database which stores a plurality of certificates, each certificate being configuration information for defining an isolated execution environment and different ones of the certificates being different configuration information;
extracting the selected certificate;
initializing an isolated execution environment based on the configuration information of the extracted certificate; and
executing the program in the isolated execution environment.
